(19) United States
(12) Patent Application Publication
(10) Pub. No.: US 2020/0126152 A1
(43) Pub. Date: Apr. 23, 2020

(54) SYSTEM AND METHOD FOR ASSET DISTRIBUTION

(71) Applicants: KIRK EDWARD VOLTZ, JR., LEESBURG, VA (US); JUSTIN ELIOT HOWELL, WASHINGTON, DC (US)

(72) Inventors: KIRK EDWARD VOLTZ, JR., LEESBURG, VA (US); JUSTIN ELIOT HOWELL, WASHINGTON, DC (US)

(21) Appl. No.: 16/654,541

(22) Filed: Oct. 16, 2019

Related U.S. Application Data
(60) Provisional application No. 62/746,932, filed on Oct. 17, 2018.

(51) Int. Cl. G06Q 40/02; G06F 3/0481; G06K 9/00

(52) U.S. Cl. CPC G06Q 40/02; G06K 9/00885; G06F 3/0481

(57) ABSTRACT

A system for management and distribution of financial assets of one or more individuals using a synthetic account is described. A synthetic account can be formed for at least one user of a financial asset management system using information obtained from the at least one user and configured to serve a specific purpose identified by the at least one user. The synthetic account is funded using a portion of funds available in at least one holding account of the at least one user to the synthetic account by isolating the portion of funds into a partition that is exclusively assigned to the synthetic account. Synthetic accounts can be formed based on one or more underlying holding accounts and can be configured to be jointly owned by more than one user.

### RELATED APPLICATIONS

The application claims the benefit of and priority to U.S. Provisional Application No. 62/746,932, filed on Oct. 17, 2018, the entire teachings of which is incorporated herein by reference.

### FIELD OF THE INVENTION

The present disclosure generally relates to distribution of assets and more particularly to systems and corresponding methods for management and distribution of financial assets using a synthetic account.

### BACKGROUND

An average individual can own a number of holding accounts, such as personal checking, savings, brokerage, and retirement account. Managing funds held in separate accounts and planning financial goals using funds in held separate accounts can be burdensome.

### SUMMARY

In one aspect, a computerized method for financial asset management is disclosed. The computerized method comprising forming a synthetic account for at least one user of a financial asset management system based on information obtained from the at least one user, allocating a portion of funds available in at least one holding account of the at least one user to the synthetic account, and funding the synthetic account using the portion of funds allocated to the synthetic account. The synthetic account can be formed to serve a specific purpose identified by the at least one user.

In another aspect, a system comprising one or more processors and a memory connected to the one or more processors is described. The memory can store one or more programs that are configured to be executed by the one or more processors. The one or more programs can include instructions that upon execution, cause the one or more processors to: form a synthetic account for at least one user of a financial asset management system based on information obtained from the at least one user, allocate a portion of funds available in at least one holding account of the at least one user to the synthetic account, and fund the synthetic account using the portion of funds allocated to the synthetic account. The synthetic account can be formed to serve a specific purpose identified by the at least one user.

In other examples, any of the aspects above, or any system, method, apparatus, and computer program product method described herein, can include one or more of the following features.

Embodiments disclosed herein can open least one holding account with a financial institution for the at least one user based on the information obtained from the at least one user. The holding account can comprise at least one of: a demand deposit account, a checking account, a saving account, an individual brokerage account, a retirement account, an individual retirement account (IRA), a Roth-IRA, a 401k account, a 529 account, a health saving account, a flexible spending account, a loan or mortgage accounts, and a credit card account.

In some embodiments, the at least one user can be provided with a user interface, presented on a display screen of a communications device of the at least one user, and the interface can be used to obtain the information from the at least one user. The information obtained from the at least one user can comprise at least one of: information used for uniquely identifying the at least one user, information relating to financial goals of the at least one user, information relating to financial needs of the at least one user, and the specific purpose identified by the at least one user. Further, the information for uniquely identifying the at least one user can comprise biometric information of the at least one user.

Further, the portion of the funds can be allocated by isolating the portion from remainder of the funds available in at least one holding account and assigning the isolated portion for use with the synthetic account.

In some embodiments, the synthetic account can be funded using funds held in at least two separate holding accounts. The at least two separate holding accounts can be owned by at least two different users. Embodiments disclosed herein can further form the synthetic account for at least two users of the financial asset management system, wherein the synthetic account is a jointly owned account owned by the at least two users and funded by funds sourced from at least two separate holding accounts owned by the at least two different users.

Other aspects and advantages of the invention can become apparent from the following drawings and description, all of which illustrate the principles of the invention, by way of example only.

### BRIEF DESCRIPTION OF THE DRAWINGS

The advantages of the invention described above, together with further advantages, may be better understood by referring to the following description taken in conjunction with the accompanying drawings. The drawings are not necessarily to scale, emphasis instead generally being placed upon illustrating the principles of the invention.

FIG. 1 is an illustrative block diagram of an asset management system according to some embodiments disclosed herein.

FIG. 2 is a high-level flow diagram of example procedures for forming a synthetic account according to embodiments disclosed herein.

FIG. 3 is a high-level block diagram illustrating allocation of funds in holding and synthetic accounts according to some embodiments disclosed herein.

FIG. 4 is a high-level illustrative block diagram of an asset management system according to some embodiments disclosed herein.

FIG. 5 is another high-level illustrative block diagram of an asset management system according to some embodiments disclosed herein.

FIG. 6 is a high-level block diagram illustrating allocation of funds in holding and synthetic accounts according to some embodiments disclosed herein.

FIG. 7 is an illustrative block diagram of an example synthetic account having underlying accounts belonging to different users.

FIG. 8 is another illustrative block diagram of an example synthetic account having underlying accounts belonging to different users.

FIG. 9 is an example illustration of digital/electronic processing circuitry computer hardware that can be used with the embodiments disclosed herein.

### DETAILED DESCRIPTION

Embodiments disclosed herein relate to systems and corresponding methods for management and distribution of financial assets of one or more individuals using a virtual or “synthetic account.” The term “synthetic account,” as used herein, refers to an account that isolates at least a portion of funds in at least one underlying holding account into a partition that is configured to provide the holder of that holding account with the capability to direct the funds in that partition towards an intended purpose. Specifically, a system according to some embodiments disclosed herein can isolate at least a portion of the funds available in a holding account into one or more partitions, each referenced herein as a “synthetic account,” and configured to allow the holder of the holding account to direct the funds in that partition towards a specific purpose (e.g., planning for retirement, buying a house, paying for a wedding, etc.).

A synthetic account formed by the embodiments disclosed herein is not a physical or holding account held by a financial institution. Rather, a synthetic account comprises a partition of at least a portion of a user's assets within one or more holding accounts. A synthetic account enables users, administrators, and/or account managers to manage, allocate, distribute, and interact with partitioned assets held in part or in whole within a single (or multiple) holding account(s). A synthetic account can be generated for a specific purpose (e.g., saving for a specific expenditure or making a specific payment). In an embodiment, the synthetic accounts may be considered administrative subaccounts of one or more holding accounts.

The term “holding account” as used herein refers to any form of institutional asset holding account that is owned by a user. Examples of holding accounts that can be used with examples disclosed herein include but are not limited to demand deposit account(s) (DDAs), checking account(s), saving account(s), individual brokerage account(s), retirement account(s), individual retirement account(s) (IRA), Roth-IRA, 401k, 529, health saving account(s), flexible spending account(s), loan or mortgage accounts(s), credit card account(s), etc. In an embodiment, a holding account is one that is held by a financial institution, such as a bank, credit union, savings and loan association, investment bank or company, brokerage firm, insurance company and/or mortgage company. In an embodiment, a holding account is a physical account held in the ledger of the financial institution.

In an embodiment, one synthetic account may be linked to, and partition assets from, multiple underlying holding accounts. In another embodiment, one holding account (a DDA account for example) may be linked to, and may be partitioned into, multiple synthetic accounts. In a particular embodiment, a single synthetic account may be linked to, and partition assets from, multiple underlying holding accounts for a particular user and a single holding account (a DDA account for example) may be linked to, and may be partitioned into, multiple synthetic accounts for the same user.

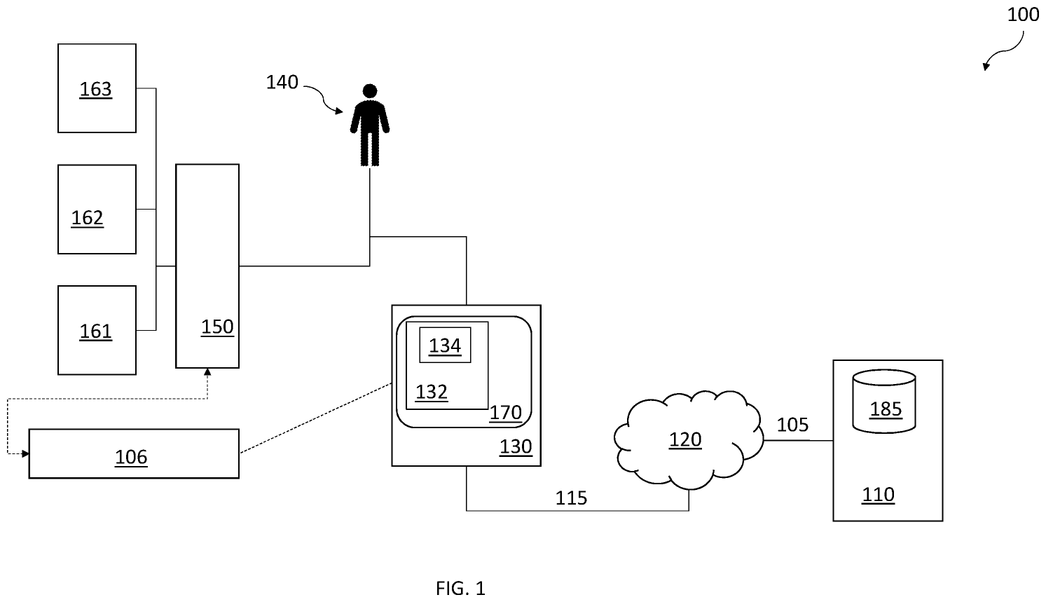

FIG. 1 is a block diagram of an asset management system 100 according to an illustrative embodiment disclosed herein. The asset management system 100 can include an account manager 110 that is coupled, via a communications network 120, with one or more user devices 130. Generally, the account manager 110 can be included in any computing suitable device designated to run one or more services or functions as a host. For example, the account manager 110 can be included in a server (not shown). If included in a server, the server can be any suitable server available in the art and offer services offered by any suitable server. For example, the account manager 110 can be included in a financial server, web server, database server, file server, mail server, gaming server, etc. Further, as detailed below, the account manager 110 and/or the user devices 130 can be implemented in computer hardware or digital processing circuitry and configured to implement various aspects of embodiments disclosed herein.

Generally, the user device 130 can comprise any suitable device known in the art and can correspond to/relate to/belong to at least one member 140 of the asset management system disclosed herein. Generally, a user device 130 can be any device that is capable of establishing a connection to the communications network 120 and/or other user devices.

The communications network 120 can be a private network (e.g., local area network (LAN)), a metropolitan area network (MAN), a wide area network (WAN), or a public network (e.g., the Internet). Further, the communications network 120 can be a hybrid communications network 120 that includes all or parts of other networks. Generally, the networks 120 can have any suitable topology (e.g., bus, star, or ring network topologies).

Examples of the user devices that can be used with the embodiments disclosed herein include, but are not limited to, workstations, wireless phones, smart phones, personal digital assistants, desktop computers, laptop computers, tablet computers, handheld computers, smart phones, network access terminals, a wearable computer, etc. The user device 130 can be configured such that it can connect to the network 120 via a communication link 115.

Depending on the type of the user device 130 used (e.g., wired or wireless device), the communication link 115 can be a wired or a wireless link. Similarly, the account manager 110 can connect to the network 120 via a communication link 105.

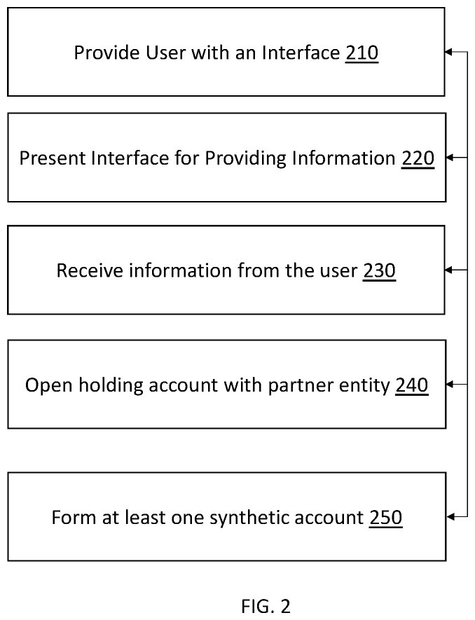

As shown in FIGS. 1-2, the asset management system 100 can provide a user 140 with a client application 132 that allows the user 140 to communicate with the asset management system 100 via a communications network 120. The client application 132 can include software configured to enable a respective user device 130 to communicate with the network 120 to request and/or receive information and/or services via the network 120. The information and/or services can be provided in software as a service (SAAS) environment. Further, the information or services receivable at the client application 132 can include deliverable components (e.g., downloadable software to configure the user device 130, or information for consumption and/or processing at the user devices 130). As such, for example, the client application 132 can include corresponding executable instructions for configuring the user device 130 to provide corresponding functionalities for distributed accounts in synthetic accounts disclosed herein.

The client application 132, upon being executed/launched on the user device 130, can present the user 140 with a user interface 134 (FIG. 2, box 210). The user interface 134 can be presented to the user on the display 170 of the user device 130 and configured to function as an input/output medium for receiving instructions directly from the user 140. This allows the user interface 134 to communicate with the account manager 110 to receive user input and/or to present output to the user as, for example, audible, visual, mechanical or other output indications. Generally, the user interface 134 can be configured to allow the user 140 to control at least some of the functions of the asset management system 100 disclosed herein.

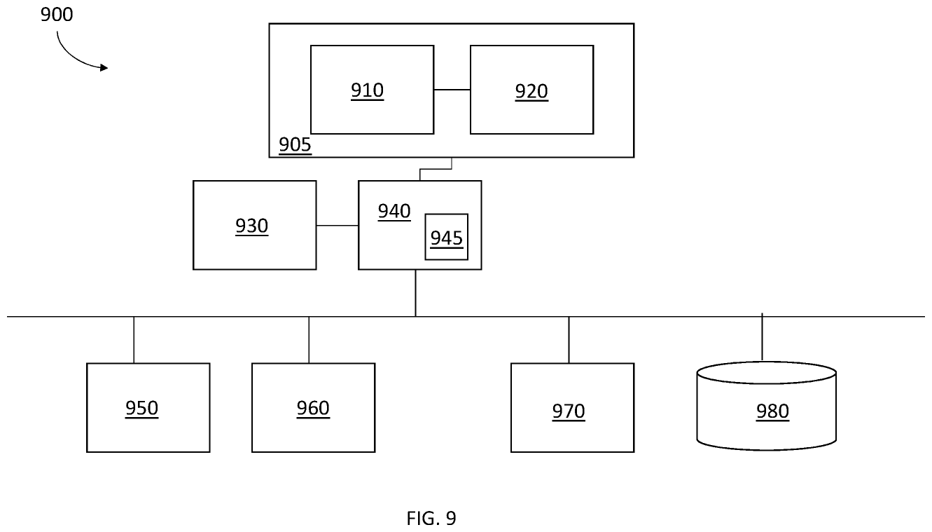

As detailed below with reference to FIG. 9, the processing circuitry of the user device 130 can be configured to implement or control at least some functions of one or more elements of the user interface 134. For example, the processing circuitry can be configured to control one or more functions of one or more elements of the user interface 134 through computer program instructions (e.g., software and/or firmware) stored on the memory of the processing circuitry (e.g., volatile memory, non-volatile memory, and/or the like).

The user interface 134 can be configured to provide the user 140 with appropriate menus, fields, prompts, keys, and/or buttons (e.g., implemented in software) for interacting with the system 100 (FIG. 2, box 220). For example, the user interface 134 can provide the user with one or more fields and menus that the user can use to provide information to the system 100.

Additionally or alternatively, the user interface 134 can be implemented in software and displayed to the user on the display 170 of the user device 140. Alternatively or additionally, the user interface can comprise a keyboard, a mouse, a joystick, a display (e.g., a touch screen display), a microphone, a speaker, or other input/output mechanisms that are configured to communicate with the user 140 and receive/forward information from/to the user 140.

Generally, the user 140 can use the user interface 134 to provide any suitable information to the system 100. For example, the user 140 can provide the system 100 with information that can be used to 1) identify the user 140 (e.g., name, address, social security number, country of citizenship, employer information, etc.), 2) identify the user's financial needs (e.g., user's income level, age, number of children, etc.), and/or 3) identify the user's financial goals (e.g., saving for a wedding, saving for kids' college tuition, saving for retirement, sharing a synthetic account with another user to pay certain bills, etc.).

Further, the client application 132 and interface 134 can be configured to allow a new user 140 to the system 100 to provide relevant information. For example, the client application 132 can be configured to allow a user to create a new account with the system, create new login information, provide her biometric information, etc.

The information provided by user 140 is forwarded to the account manager 110 via the interface 134 of the client application 132 (FIG. 2, box 230). As noted, the account manager 110 can be connected to the user device 130 via the communication network 120.

The account manager 102 can include a database 180 configured to store information regarding the asset management system 100. For example, the database 180 of the account manager 110 can comprise an allocated amount of storage in its database 180 that maintains a list of all user devices 130. The account manager 110 can also maintain information regarding each user's financial assets in the database 180. Further, in some embodiments, the account manager 110 can maintain information that can be used to identify each user 140. For example, the account manager 110 can maintain information (e.g., login and password information) that can be used to uniquely identify and/or authenticate a user 140. Further, in some embodiments, the account manager 110 can maintain information (e.g., IP addresses) that can be used to uniquely identify a user 140.

The database 185 can further include various other information, including but not limited to information that can be used to 1) identify the user 140 (e.g., name, address, social security number, country of citizenship, employer information, etc.), 2) identify the user's financial needs (e.g., user's income level, age, risk tolerance, number of children, etc.), and/or 3) identify the user's financial goals (e.g., saving for a wedding, saving for kids' college tuition, saving for retirement, etc.).

The account manager 110 can be configured to use the information stored in the database 185 to identify the user device 130 and/or the user 140. For example, the account manager 110 can use the identifying information (e.g., login, password, IP address, biometric information (e.g., facial recognition, finger print, iris scan, etc.)) to uniquely identify the user 140.

The account manager 110 can also employ the information in the database 185 to perform asset management functions for the user 140. For example, the account manager 110 can use the information provided by the user 140 to open one or more holding accounts 150 for the user (FIG. 2, box 240). In some embodiments, the account manager 110 can determine the type of holding accounts 150 to open for the user 140 by analyzing the user's information (e.g., user's age, income, liquid assets, etc.) and financial goals (e.g., saving for retirement, access to immediate liquid assets, etc.).

The account manager 110 can open the holding account 150 by forwarding relevant information about the user 140 to a partner entity 106 along with instructions for opening a specific type of holding account 150. For example, in order to open a DDA holding account 150, the account manager 110 can forward relevant information of the user 140 (e.g., name, date of birth, social security number, etc.) to a partner banking institution 106 that offers DDA accounts and instruct the partner institution 105 to open a DDA account for the user 140. Once the holding account 150 is opened, the account manager 110 can store relevant information regarding the holding account 150 (e.g., name of the partner entity 106, holding account number, information for accessing the holding account 110 through the partner entity 106, etc.) in the database 185 of the account manager 110.

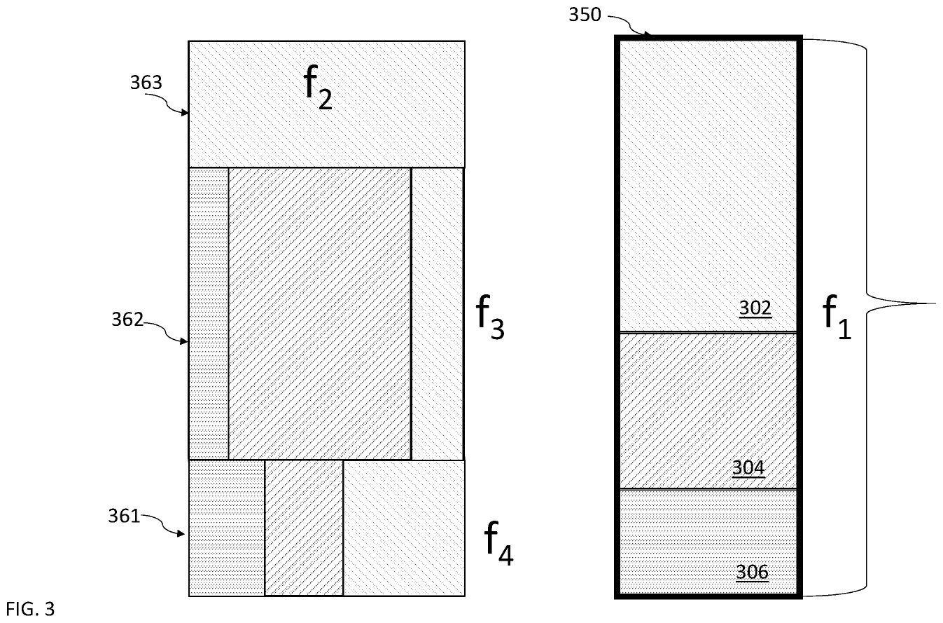

The account manager 110 can further be configured employ the information obtained from the user to form at least one synthetic account 161, 162, 163 based on the at least one holding account 150 of the user (FIG. 2, box 250). Specifically, as shown in FIG. 3, the account manager can partition in funds f1 in the holding account 350 into one or more synthetic accounts 361, 362, 363, each holding a portion f2, f3, f4 of the funds in the holding account 350. This configuration allows the user to view the funds f1 in the holding account 350 as having been partitioned/divided into at least one synthetic account 361, 362, 363. Specifically, although the funds f1 in the holding account 350 physically remain in the holding account 350 and are not moved or transferred to any other holding account(s), the account manager 110 treats the funds f1 as though at least a portion of the funds (e.g., portions f2, f3, f4) is held in a separate account (i.e., a synthetic account 361, 362, 363). The funds f1, however, remain in the holding account 350, while appearing to the user as being split/partitioned into one or more synthetic accounts 361, 362, 363.

In some embodiments, the account manager 110 can provide the user with at least some information regarding the purpose of the one or more synthetic accounts 316, 362, 363 (e.g., saving for retirement, planning a wedding, mortgage and bill payment, etc.) and/or how the funds in the holding account 350 are allocated. Once partitioned into the synthetic accounts, the user can view the partitions in a synthetic account view that allows the user to interact with the synthetic accounts 316, 362, 363. The synthetic account view 320 can be presented to the user via the client application 132, for example on the user interface 134 of the client application 132. For example, the account manager 110 may display a pie chart indicated how much of the desired “wedding savings” synthetic account has been saved to date and/or what parties contributed to a particular synthetic account for payment of certain bills.

In an embodiment, the holding account 350 can be an individual brokerage account which holds a total sum f1 of assets (specific dollar value, e.g., $16,000). The assets may be held in a variety of positions and/or in various forms. For example, a portion 302 of the assets in the holding account 350 can be held in cash (e.g., approximately 37.5% of the funds, for example $6,000), while the remaining portions 304, 306 can be held in bonds and stocks. For example, the holding account 310 can comprise $5,500 of bonds (e.g., about 34.3%) and $4,500 in stocks (e.g., about 28.1%). The account manager can configure the synthetic accounts such that each account contains at least a portion of the funds in the holding account. In situations where the holding account contains more than one type of funds (e.g., mixture of cash, stocks, etc.), the account manager can determine the type of funds that are used to fund a synthetic account based on the intended purpose of that synthetic account. For example, the fund manager can fund a synthetic account 363 intended for immediate use (e.g., synthetic account with funds intended for payment of that month's mortgage, rent, credit card bills, etc.) with liquid funds (e.g., cash) that can be immediately used. Similarly, short-term savings accounts, such as a synthetic account 361 intended for use to pay for a wedding in the next year, can be funded in a risk adverse manner, for example with a combination of cash and bonds. Long-term savings accounts 362, such as synthetic account intended to use for retirement in forty years, can be configured to be more risk tolerant, and contain funds such as a combination of stocks, bonds, and cash.

As noted, the account manager can partition at least a portion of the funds in the holding account 350 into one or more isolated synthetic accounts that are funded by the underlying holding account 350. In some embodiments, all of the funds f1 in the holding account 350 can be placed into one or more synthetic accounts. Additionally or alternatively, the one or more synthetic accounts can be configured to include a portion of the funds in the holding account 310, while leaving at least a portion of the funds in the holding account 350 unpartitioned.

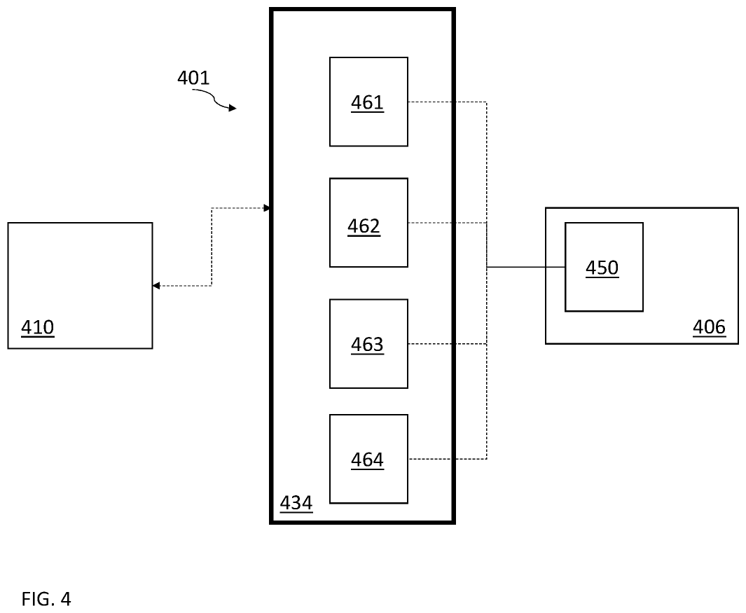

As shown in FIG. 4, the user interface 434 can provide the user with a synthetic account view 401 that allows the user to view, interact with, and manage each synthetic account 461, 462, 463, 464, independently. Each of the synthetic accounts 461, 462, 463, 464 can be formed for a specific reason and have its own specific and customized asset allocation rules. For example, the user may wish to maintain an emergency cash fund 461 in which a set amount of cash is isolated (e.g., $1,000). The account manager 410 can form this synthetic account 461 by isolating $1,000 of the portion of the holding account 450 (held by a partner entity 406) that is held in cash. Similarly, the user may wish to save money for a home down payment in a synthetic account 462 and have an education fund in another synthetic account 463. The user 140 can indicate to the account manager the portion of the assets in the holding account that he/she wishes to maintain in each of these synthetic accounts 461, 462, 463. In response, the account manager 110 can partition at least a portion of the user's holding account to form the requested synthetic account(s) 461, 462, 463.

The account manager 410 can provide users, administrators, or account managers with the ability to create an unlimited number of synthetic accounts using a single holding account. Funds isolated within a synthetic account can be deposited, withdrawn and managed in isolation from the remainder of the funds in the holding account and/or in isolation from any funds in another synthetic account. This interaction only impacts the isolated portion of the assets in the holding account and does not impact the remainder of the assets in the holding account. This partitioning of the holding account into one or more synthetic accounts can also allow specific distribution, asset allocation model, glidepath, and rebalance logic to be applied to the synthetic account rather than the entire holding account. Further, this partitioning of accounts can allow users, administrators, and account managers to establish multiple synthetic accounts, each with a separate asset allocation model. Synthetic accounts can be created, deleted and interacted without the need to create new holding accounts for each asset allocation model.

In an embodiment, by partitioning the holding account 410 into one or more isolated synthetic accounts 461, 462, 463, the account manager 410 can provide the user with goal-oriented synthetic accounts that are formed and maintained for a specific purpose without requiring the user to open an actual holding account and/or transfer funds from an existing holding account 450 into a separate holding account. For example, assuming the user wishes to allocate and save a set amount of funds ($600) for his rent payments, the user can use the account manager 410 to set up a synthetic account 464 that holds the set amount of funds ($600) in cash on a monthly basis. The account manager 410 can be configured to hold and isolate the funds from the portion of the holding account 410 that is held in cash. In an embodiment, in the event that the holding account does not contain enough cash to cover the rent payment, the account manager 410 can be configured to liquidate some of the securities in the holding account to ensure that enough cash is isolated for the monthly rent payments.

Further, in addition to forming the synthetic accounts 461, 462, 463, 464, the account manager 410 can also manage the distribution of assets among the synthetic accounts 461, 462, 463, 464 and/or within the underlying holding account 410. For example, upon determining that a synthetic account 461 needs to be rebalanced, instead of initiating a trade within that synthetic account 461 immediately, the account manager 410 can consider the assets and positions held in the other synthetic accounts 461, 462 and/or the assets and positions held in the underlying holding account 450 to determine whether a rebalancing can be achieved by moving assets between the holding account 450 and the synthetic accounts 461, 462, 463, 464 and/or by moving assets among the synthetic accounts 461, 462, 463, 464. After determining the collective number of trades and transaction needed, the account manager 410 can optimize the collective number of transactions determine the optimal number of trades that is needed to achieve the desired rebalancing. By optimizing and reducing the number of trades, the account manager 410 can minimize the cost associated with trades and possible tax implications associated with sale of securities.

The account manager 410 can form the one or more synthetic accounts by encapsulating the underlying holding account and dividing the holding account into a number of synthetic accounts. Generally, there is no limit to the number of synthetic accounts that can be created. In some embodiments, the account manager 410 maintains separate ledgers of both the holding accounts and the synthetic accounts. The account manager 410 can reconcile these ledgers on a regular basis. This allows the account activity to be provided and reconciled within each synthetic account, across all synthetic accounts, and across the holding account servicing those synthetic accounts.

It should be noted that a synthetic account can serve more than one purpose. For example, the account manager 410 can form any of a synthetic saving account with multiple purposes, a synthetic investment accounts with multiple purposes, a synthetic spending accounts with multiple purposes, and/or a synthetic retirement accounts with multiple purposes.

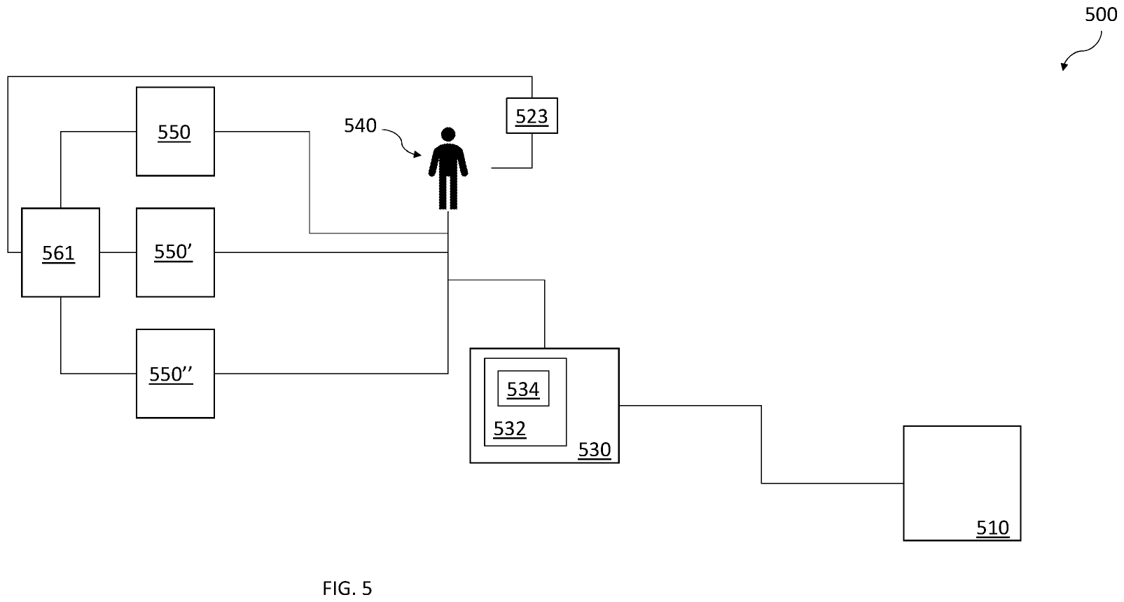

Further, in some embodiments, a synthetic account can be serviced/funded by more than one holding account. FIG. 5 is an illustrative example block diagram of an asset management system 500 in which a synthetic account 561 is funded by more than one holding account 550, 550′, 550″. As shown, a user's holding accounts can comprise a DDA account 550, a stable interest rate savings account 550′, and a tax-advantaged health savings account (HSA) 550″. The user 540 can use the account manager 510 to form a synthetic account 561 for managing his health expenses (health fund). As shown, the client application 532 and the user interface 534 can allow the user 540 to view his synthetic health fund. The synthetic account 561 can be coupled to a debit card 523 that the user can use for his health-related expenses. Therefore, the synthetic account 561 can be a distributed asset synthetic account that has access to multiple holding accounts. This allows the user 540 to interact with multiple holding accounts in order to accomplish the goal of the interaction (covering health-related expenses). For example, in the context of the example synthetic account 561 established for health purposes, when using the debit card 523 attached to the synthetic account 561 to pay for a gym membership or vitamins, the assets used for the transaction are directly withdrawn from the DDA 550. However, when making a purchase from a pharmacy or another qualifying medical expense, the assets within the HSA 550″ can be used. Further, in the event that the HSA 550″ cannot fully cover the expense, assets in the DDA 550 can cover the shortfall.

Similarly, a synthetic account could be funded by a DDA and a brokerage account. The synthetic account may have a debit card associated with the synthetic account (which would not typically be possible with a brokerage account). When the user uses the debit card, the system may determine that the funds should be withdrawn from the DDA. If the user uses the debit card in a manner in which the funds in the DDA are insufficient to cover the expenses, the account manager may sell certain assets in the brokerage account and optionally transfer those assets to the DDA in order to fund the purchase.

To form a synthetic account having more than one underlying holding account, the connection manager 510 can partition at least a portion of two or more holding accounts 550, 550′, 550″ and aggregate the funds in the partition(s) formed in each account to fun the synthetic account 561. Although shown as a single synthetic account 561, it should be understood that any suitable number of synthetic accounts 561 can be implemented based on multiple underlying holding accounts. For example, the account manager 510 can use a portion of the funds in the DDA account 550, a portion of the funds in the stable interest rate account 550′, and the funds in the HSA 550″ account to fund a synthetic account 561 for health management. Meanwhile, the account manager 510 can use another portion of the funds in the DDA account to create another synthetic account (not shown) for bill payment. Meanwhile, yet another portion of the funds in the DDA account 550 along with a portion of the funds in the a stable interest rate savings account 550′ can be used to fund a third synthetic account (not shown) for planning for retirement.

Further, in some embodiments, the account manager 110 maintains separate ledgers of both the holding accounts and the synthetic accounts. The account manager 110 can reconcile these ledgers on a regular basis.

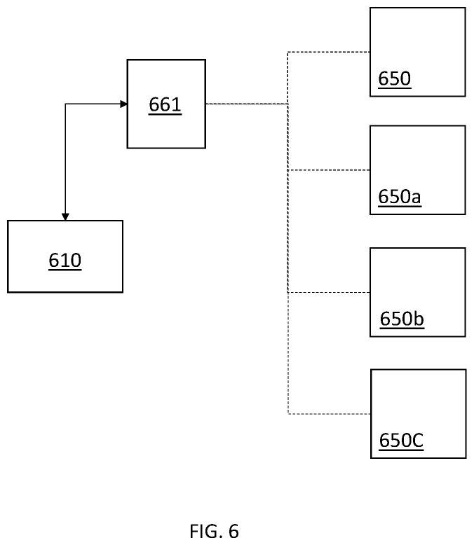

Synthetic accounts funded by multiple holding accounts can be used for any suitable purpose known in the art. For example, embodiments disclosed herein can be used to form synthetic accounts having underlying tax advantaged, non-tax advantage, and company sponsored holding accounts. For example, as shown in FIG. 6, a synthetic retirement account 661 can comprise assets held in various retirement accounts, such as a tax advantaged traditional IRA 650, a tax advantaged Roth IRA 650a, a brokerage account holding long term investments 650b, and an employer provided 401K 650c. As assets aggregated in the synthetic retirement account 661 are funded by multiple underlying retirement accounts 650, 650a, 650b, 650c, the user and the account manager 610 can optimize the aggregate performance of the synthetic account funded by these holding accounts, based on factors such as deposit amount within the current year, age, costumer preferences, etc. This allows the account manager 610 and the user to be able to manage the user's retirement funds as a single account, even if the holding accounts are provided by different providers.

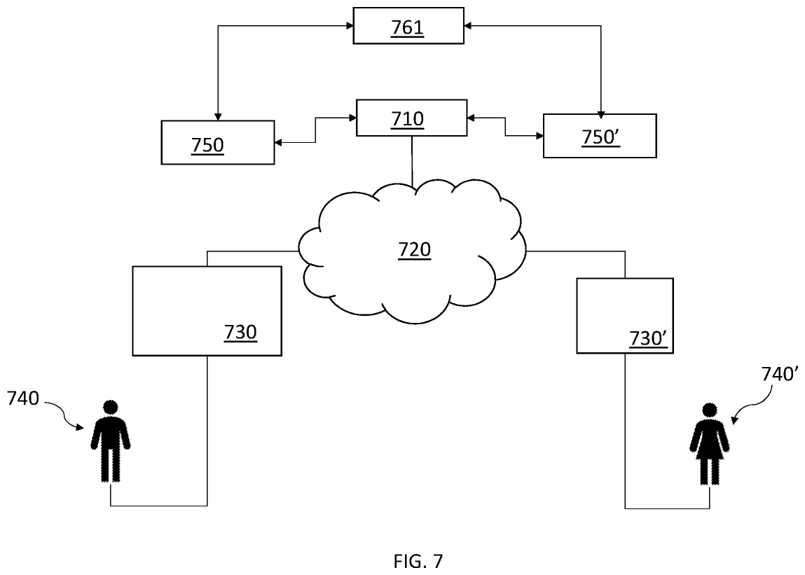

Further, in some embodiments, the account manager 710 can be configured to allow multiple users 740, 740′, each having his/her own corresponding holding accounts to form one or more synthetic accounts that are shared between the users 140, 140′. Specifically, as shown in FIG. 7, one or more users 740, 140′ can connect to the account manager 710 via their respective user devices 730, 730′ (through a network 720) and request formation of at least one joint synthetic account 761. The joint synthetic account 761 can be configured to have any suitable joint purpose (e.g., a couple saving for retirement, roommates paying rent together, etc.). Thus, the joint synthetic account 761 may be used for saving purposes or spending purposes.

Each user 740, 740′ can have his/her holding account(s) and/or the account can be jointly owned by at least two of the users. For example, each user 740, 740′ can have his/her DDA account 750, 750′. In order to form a joint synthetic account 761, the account manager 710 can partition at least a portion of the funds in each user's holding account 750, 750′ into the joint synthetic account 761. The account manager 750 can consider any suitable factor in partitioning and allocation of the funds. For example, the account manager 750 can receive the amount and/or percentage of funds that each user wishes to contribute to the synthetic account from the users and uses that information in allocating the funds from the users' holding accounts 750, 750′. For example, while two roommates may wish to split their rent in half, a married couple saving for retirement may wish to allocate a larger portion of a higher-earning spouse's salary to their retirement (e.g., 10% of the higher-earning spouse's salary and 5% of the lower-earning spouse's salary). The account manager 710 can consider such information from the users in allocating the funds from their respective holding accounts and partitioning the funds into their joint synthetic account 761.

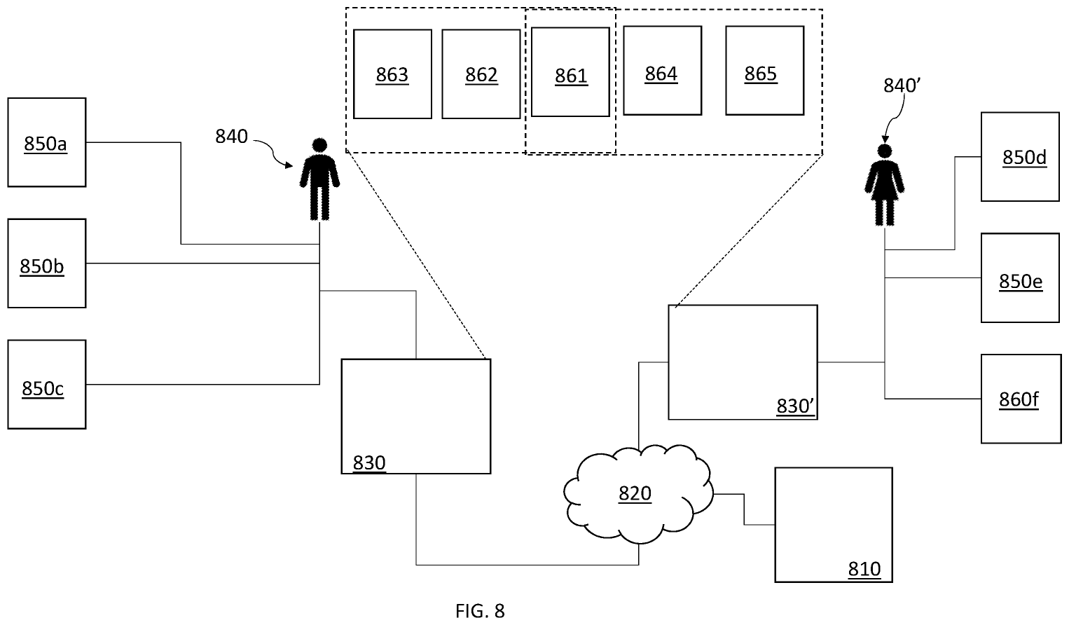

As shown in FIG. 8, a joint synthetic account 861 can be formed in addition to personalized synthetic accounts 862, 863, 864, 865. Specifically, each user 840, 840′ can employ the account manager 810 (through the use of a respective communications device 830, 830′ connected to the account manager 810 via a network 820) to set up one or more synthetic accounts 862, 863, 864, 865 based on his/her own holding accounts 850a, 850b, 850c, 850d, 850e, 850f. The user 840, 840′ can also form a joint synthetic account (for any suitable purpose) with one or more other users.

For example, in the example shown in FIG. 8, a user 840 can have a DDA account 850a, a savings account 850b, and a brokerage account 850c. The user 840 can use these accounts to fund one or more synthetic accounts 862, 863, for example for saving for retirement and for purchasing a home. The user 840 can also employ the account manager 810 to form a joint synthetic account 861 (e.g., for rent payment) with another user 840′. The first user 840 can initiate creation of the joint account 861 by setting up an account 861 and inviting another user 840′ to share the account.

The second user 840′ can also have his/her own holding accounts, for example a DDA account 850d, a brokerage account 850e, and a health savings account 860f. In addition to the joint account 861, the second user 840′ can also employ the account manager 810 to form her own individual synthetic accounts 864, 865, for example an account for saving for a wedding 864, and an account for covering health expenses 865.

This arrangement allows the users 840, 840′ to have both individual and shared distributed asset synthetic accounts. Further, by creating a synthetic account which is funded by holding accounts owned by two or more users, each user is able to see and interact with at least a portion of the assets held by a different user's holding account. Users 840, 840′ can define a specific portion of assets allocated to shared interaction, while still maintaining assets that are not available to another party within the same holding account. For example, a married couple consisting of a first user 840 and a second user 840′ can have multiple synthetic accounts 862/863, 864/865, which are derived from their personal holding accounts and are only available to each individual user 840, 840′. The users 840, 840′ can also hold a joint synthetic account 861 that is configured to hold a portion of each of their holding account assets. For example, the joint synthetic account 861 can be an account that holds a pre-defined portion of each user's 840, 840′ holding accounts. In the event the joint synthetic account 861 is used for making an investment, trades are made on behalf of each user 840, 840′, within each user's holding accounts and displayed as a collective whole within the shared synthetic account 861.

In an embodiment, the funds in a joint synthetic account may appear to be comingled (i.e. $124.00 from User 1 and $76.00 from User 2, totaling $200.00, in a synthetic account designated for payment of the utility bill), but the assets in each user's holding account(s) are not actually comingled. In this embodiment, the assets in each user's holding account may not be transferred until it is time for payment of the utility bill, in which case, the assets in the holding account are immediately transferred to the utility company.

Synthetic accounts serviced by multiple holding accounts for multiple users can be used for any suitable purpose known in the art. For example, embodiments disclosed herein can be used to form shared synthetic accounts between couples, across business owners, between roommates, across charity or sponsorship endeavors, across friends and colleagues, across employees, between parents and children, and across foundations.

In some embodiments, the inventive system provides consolidated reporting documents related to the synthetic accounts and, in various embodiments, the underlying holding accounts. The reporting may provide the user with quantitative financial information as well as more qualitative information related to progress of the desired financial goals, recommendations for adjustments, future needs to be considered, etc.

In certain embodiments, for each user, the inventive system opens (or directs a third party to open) at least one holding account, maintains a real-time ledger of each holding account, opens at least one synthetic account associated with at least one holding account, maintains a real-time ledger of each synthetic account, transfers assets between various holding accounts, pays third party bills on behalf of users (as directed), and provides various reports and advice to users related to their savings/spending goals.

FIG. 9 is a high-level block diagram of digital/electronic processing circuitry 900 or computer hardware that can be used with the embodiments disclosed herein. Without limitation, the techniques described herein can be implemented in digital electronic circuitry or in computer hardware that executes firmware, software, or combinations thereof, for example. The implementation can be as a computer program product (e.g., a computer program tangibly embodied in a machine-readable storage device, for execution by, or to control the operation of, data processing apparatus, such as a programmable processor, a computer, or multiple computers).

Generally, the program codes that can be used with the embodiments disclosed herein can be implemented and written in any form of programming language, including compiled or interpreted languages, and can be deployed in any form, including as a stand-alone program or as a component, module, subroutine, or other unit suitable for use in a computing environment. A computer program can be configured to be executed on a computer, or on multiple computers, at one site or distributed across multiple sites and interconnected by a communications network, such as the Internet.

Further, the methods and procedures for carrying out the methods disclosed herein can be performed by one or more programmable processors executing a computer program to perform functions of the invention by operating on input data and generating output. Further, The methods and procedures disclosed herein can also be performed by, and the apparatus disclosed herein can be implemented as, special purpose logic circuitry, such as an FPGA (field programmable gate array) or an ASIC (application specific integrated circuit). Modules and units disclosed herein can also refer to portions of the computer program and/or the processor/special circuitry that implements that functionality.

Referring back to FIG. 9, the digital electronic circuitry 900 can comprise a main memory unit 905 that is connected to a processor 940 and a cache unit 930 configured to store copies of the data from the most frequently used main memory 905.

The processor 940 can be any suitable processor for execution of a computer program. For example, the processor 940 can be a general and/or special purpose microprocessor and/or a processor of a digital computer. The processor can be configured to receive and execute instructions received from the main memory 905.

Further, the processor 940 can comprise a central processing unit (CPU) 945 that includes processing circuitry configured to manipulate instructions received from the main memory 920 and execute various instructions. The CPU 945 can be any suitable processing unit known in the art. For example, the CPU 945 can be a general and/or special purpose microprocessor, such as an application-specific instruction set processor, graphics processing unit, physics processing unit, digital signal processor, image processor, coprocessor, floating-point processor, network processor, and/or any other suitable processor that can be used in a digital computing circuitry. Alternatively or additionally, the processor can comprise at least one of a multi-core processor and a front-end processor.

Generally, the processor 940 can be embodied in any suitable manner. For example, the processor 940 can be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. Additionally or alternatively, the processor 940 can be configured to execute instructions stored in the memory 905 or otherwise accessible to the processor 940. As such, whether configured by hardware or software methods, or by a combination thereof, the processor 940 can represent an entity (e.g., physically embodied in circuitry) capable of performing operations according to embodiments disclosed herein while configured accordingly. Thus, for example, when the processor 940 is embodied as an ASIC, FPGA or the like, the processor 940 can be specifically configured hardware for conducting the operations described herein. Alternatively, as another example, when the processor 940 is embodied as an executor of software instructions, the instructions can specifically configure the processor 940 to perform the operations described herein.

The processor 940 and the CPU 945 can be configured to receive instructions and data from the main memory 905 (e.g., a read-only memory or a random access memory or both) and execute the instructions. The instructions and other data can be stored in the main memory 905. The processor 940 and the main memory 905 can be included in or supplemented by special purpose logic circuitry. The main memory 905 can be any suitable form of volatile memory, non-volatile memory, semi-volatile memory, or virtual memory included in machine-readable storage devices suitable for embodying data and computer program instructions. For example, the main memory 920 can comprise magnetic disks (e.g., internal or removable disks), magneto-optical disks, one or more of a semiconductor memory device (e.g., EPROM or EEPROM), flash memory, CD-ROM, and/or DVD-ROM disks.

The main memory 905 can comprise an operating system 910 that is configured to implement various operating system functions. For example, the operating system 910 can be responsible for controlling access to various devices, memory management, and/or implementing various functions of the asset management system disclosed herein. Generally, the operating system 910 can be any suitable system software that can manage computer hardware and software resources and provide common services for computer programs.

The main memory 905 can also hold application software 920. For example, the main memory 905 and application software 920 can include various computer executable instructions, application software, and data structures, such as computer executable instructions and data structures that implement various aspects of the embodiments described herein. For example, the main memory 905 and application software 910 can include computer executable instructions, application software, and data structures, such as computer executable instructions and data structures that implement various aspects of the asset management systems disclosed herein, such as formation of synthetic accounts. Generally, the functions performed by the asset management systems disclosed herein can be implemented in digital electronic circuitry or in computer hardware that executes software, firmware, or combinations thereof. The implementation can be as a computer program product (e.g., a computer program tangibly embodied in a non-transitory machine-readable storage device) for execution by or to control the operation of a data processing apparatus (e.g., a computer, a programmable processor, or multiple computers).

The processor 940 can further be coupled to a database or data storage 980. The data storage 980 can be configured to store information and data relating to various functions and operations of the asset management systems disclosed herein. For example, as detailed above, the data storage 980 can store information including but not limited to information that can be used to 1) identify the users of the asset management systems (e.g., name, address, social security number, country of citizenship, employer information, etc.), 2) identify the users' financial needs (e.g., user's income level, age, risk tolerance, number of children, etc.), and/or 3) identify the users' financial goals (e.g., saving for a wedding, saving for kids' college tuition, saving for retirement, etc.).

The processor 940 can further be coupled to a display 970. The display 970 can be configured to display information and instructions received from the processor 940. Further, the display 970 can generally be any suitable display available in the art, for example a Liquid Crystal Display (LCD) or a light emitting diode (LED) display. Furthermore, the display 970 can be a smart and/or touch sensitive display that can receive instructions from a user and forwarded the received information to the processor 940.

The processor 940 can further be connected to various interfaces. The connection to the various interfaces can be established via a system or an input/output (I/O) interface 960 (e.g., Bluetooth, USB connector, audio interface, FireWire, interface for connecting peripheral devices, etc.). The processor 940 can further be coupled to a communication interface 950, such as a network interface that provides the digital circuitry 900 with a connection to a suitable communications network, such as the Internet (e.g., via any suitable communications means such as a wired or wireless communications protocols including WIFI and Bluetooth communications schemes). Transmission and reception of data, information, and instructions can occur over the communications network.

Generally, communication through the communication interface 950 can be conducted be any means, such as a device or circuitry embodied in either hardware, software, or a combination of hardware and software that is configured to receive and/or transmit data from/to a network and/or any other device or module in communication with the apparatus. The communication interface 950 can comprise, for example, an antenna (or multiple antennas) and supporting hardware and/or software for enabling communications with a network (e.g., the network 120) or other devices (e.g., user device 130).

In some implementations, the communication interface 950 can, alternatively or additionally, be configured to support wired communication. As such, for example, the communication interface 950 can include a communication modem and/or other hardware/software for supporting communication via cable, digital subscriber line (DSL), universal serial bus (USB) or other mechanisms. In some embodiments, the communication interface 950 can support communication via one or more different communication protocols or methods. In some cases, IEEE 802.15.4 based communication techniques such as ZigBee or other low power, short range communication protocols, such as a proprietary technique based on IEEE 802.15.4 can be employed along with radio frequency identification (RFID) or other short range communication techniques. In other embodiments, communication protocols based on the draft IEEE 802.15.4a standard can be established.

What is claimed is:

1. A computerized method for financial asset management, the method comprising:
forming a synthetic account for at least one user of a financial asset management system based on information obtained from the at least one user, the synthetic account being formed to serve a specific purpose identified by the at least one user;
allocating a portion of funds available in at least one holding account of the at least one user to the synthetic account; and
funding the synthetic account using the portion of funds allocated to the synthetic account.

2. The computerized method of claim 1, wherein the holding account comprises at least one of: a demand deposit account, a checking account, a saving account, an individual brokerage account, a retirement account, an individual retirement account (IRA), a Roth-IRA, a 401k account, a 529 account, a health saving account, a flexible spending account, a loan or mortgage accounts, and a credit card account.

3. The computerized method of claim 1, further comprising providing the at least one user with a user interface, presented on a display screen of a communications device of the at least one user, and obtaining, via the user interface, the information from the at least one user.

4. The computerized method of claim 1, wherein the information obtained from the at least one user comprises at least one of: information used for uniquely identifying the at least one user, information relating to financial goals of the at least one user, information relating to financial needs of the at least one user, and the specific purpose identified by the at least one user.

5. The computerized method of claim 4, wherein the information for uniquely identifying the at least one user comprises biometric information of the at least one user.

6. The computerized method of claim 1, further comprising opening the at least one holding account with a financial institution for the at least one user based on the information obtained from the at least one user.

7. The computerized method of claim 1, further comprising allocating the portion of the funds by isolating the portion from remainder of the funds available in at least one holding account and assigning the isolated portion for use with the synthetic account.

8. The computerized method of claim 1, further comprising funding the synthetic account using funds held in at least two separate holding accounts.

9. The computerized method of claim 8, wherein the at least two separate holding accounts are owned by at least two different users.

10. The computerized method of claim 1, further comprising forming the synthetic account for at least two users of the financial asset management system, wherein the synthetic account is a jointly owned account owned by the at least two users and funded by funds sourced from at least two separate holding accounts owned by the at least two different users.

11. A system comprising:
one or more processors;
a memory connected to the one or more processors; and
one or more programs stored in the memory and configured to be executed by the one or more processors; the one or more programs including instructions that upon execution, cause the one or more processors to:
form a synthetic account for at least one user of a financial asset management system based on information obtained from the at least one user, the synthetic account being formed to serve a specific purpose identified by the at least one user;
allocate a portion of funds available in at least one holding account of the at least one user to the synthetic account; and
fund the synthetic account using the portion of funds allocated to the synthetic account.

12. The system of claim 11, wherein the holding account comprises at least one of: a demand deposit account, a checking account, a saving account, an individual brokerage account, a retirement account, an individual retirement account (IRA), a Roth-IRA, a 401k account, a 529 account, a health saving account, a flexible spending account, a loan or mortgage accounts, and a credit card account.

13. The system of claim 11, wherein the instructions, upon execution, cause the one or more processors to provide the at least one user with a user interface, presented on a display screen of a communications device of the at least one user, and obtain, via the user interface, the information from the at least one user.

14. The system of claim 11, wherein the information obtained from the at least one user comprises at least one of: information used for uniquely identifying the at least one user, information relating to financial goals of the at least one user, information relating to financial needs of the at least one user, and the specific purpose identified by the at least one user.

15. The system of claim 14, wherein the information for uniquely identifying the at least one user comprises biometric information of the at least one user.

16. The system of claim 11, wherein the instructions, upon execution, cause the one or more processors to open the at least one holding account with a financial institution for the at least one user based on the information obtained from the at least one user.

17. The system of claim 11, wherein the instructions, upon execution, cause the one or more processors to allocate the portion of the funds by isolating the portion from remainder of the funds available in at least one holding account and assign the isolated portion for use with the synthetic account.

18. The system of claim 11, wherein the instructions, upon execution, cause the one or more processors to funding the synthetic account using funds held in at least two separate holding accounts.

19. The system of claim 8, wherein the at least two separate holding accounts are owned by at least two different users.

20. The system of claim 11, wherein the instructions, upon execution, cause the one or more processors to form the synthetic account for at least two users of the financial asset management system, wherein the synthetic account is a jointly owned account owned by the at least two users and funded by funds sourced from at least two separate holding accounts owned by the at least two different users.
